(19) United States
(12) Patent Application Publication
(10) Pub. No.: US 2005/0161535 A1
(43) Pub. Date: Jul. 28, 2005

(54) Apparatus and method for operating spray guns

(76) Inventors: Ben Cizowski, Gurnee, IL (US); George William Frasemer, Gages Lake, IL (US)

Correspondence Address: Benjamin Cizowski, 1001 Kilbourne Rd., Gumee, IL, 60031, US

(21) Appl. No.: 10/762,797

(22) Filed: Jan. 22, 2004

(51) Int. Cl. B05B 7/02; B05B 9/01

(52) U.S. Cl. 239/525; 239/526

(57) ABSTRACT

An apparatus and method for increasing the distance reached by the spray from a spray gun include the use of a trigger (200) having a first grasping position (220) and a second grasping position (230) are described. The trigger (200) attaches to a gun body (250) that is mounted to a handle (255). The trigger (200) includes a bend (240) that connects the first grasping position (220) to a second grasping position (230) and allows the trigger (200) to be squeezed proximately close to a handle (255) without interference with a hand rest (265) of the handle (255).

### CROSS-REFERENCE TO RELATED APPLICATIONS

Not Applicable

### STATEMENT REGARDING FEDERALLY SPONSORED RESEARCH/DEVELOPMENT

The present invention does not involve any form of federally sponsored research or development.

### BACKGROUND OF THE INVENTION

Devices and methods for operating spray guns, particularly for painting, are known. Spray guns can be designed to control spray patterns, the flow rate of fluids leaving the spray gun nozzle including their relative flow rates, the sequence of fluid delivery, the undesirable accumulation of liquid such as dripping paint, and the mixing of fluid such as paint and atomizing air. Spray guns operate by grasping a trigger and squeezing it towards a handle. The design and position of the trigger determines the distance that can be reached by the spray from the spray gun nozzle relative to the hand that operates the spray gun. Typically, triggers include a straight section with a single grasping point and are difficult to grasp from an extended trigger position.

When using a spray gun, particularly for the application of paint, an interruption of fluid spray can affect the final appearance or a desired result of the spraying. For example, a portion of an object can be physically out of reach and can require an interruption of paint spraying to change position. A change in position can require positioning a ladder or changing the position of the object being painted so that the unpainted portion can be painted. During the time needed to change position, the paint that has already been applied can dry enough such that further application of paint can result in a non-uniform appearance in the painted surface. Thus, a need to change position can increase the time needed to paint an object, and produce a poorer result.

Accordingly, there is a need for an apparatus for and method of spraying with a spray gun, which apparatus includes a trigger that is pivotally and operationally attached to a spray gun body and having at least two grasping positions for operating the spray gun, and which method increases spray reach by operating the spray gun from an extended position on the trigger.

### BRIEF SUMMARY OF THE INVENTION

An apparatus and a method for spraying fluid from a spray gun are provided. The apparatus includes a spray gun body attached to a handle, a trigger pivotally and operationally connected to the spray gun body, and at least two grasping positions on the trigger for operating the spray gun. The steps of the method include spraying a fluid by grasping a spray gun at a first position on the trigger, and moving a grasping hand to a second trigger position that is farther away from the spray gun nozzle and increases the reach of the spray.

### BRIEF DESCRIPTION OF THE DRAWINGS

FIG. 1 illustrates an apparatus having two grasping positions that is used for operating of a spray gun in accordance with the invention.

FIG. 2 illustrates an embodiment of an apparatus having a trigger having two grasping positions as used for operating a spray gun in accordance with the invention.

FIG. 3 is a flowchart illustrating a method for use in spraying with a spray gun.

### DETAILED DESCRIPTION OF THE PREFERRED EMBODIMENT

The present invention includes an apparatus and method for spraying a fluid, such as paint, from a spray gun. The apparatus includes a gun body attached to a handle, and a trigger that is pivotally and operationally attached to the gun body and having at least two grasping positions. Grasping positions are located along the length of the trigger that operates the spray gun. Grasping positions can be used to operate the spray gun trigger at extended distances from the spray gun body. Operating the trigger at extended distances from the spray gun body can be used to increase the distance that spray from the spray gun reaches.

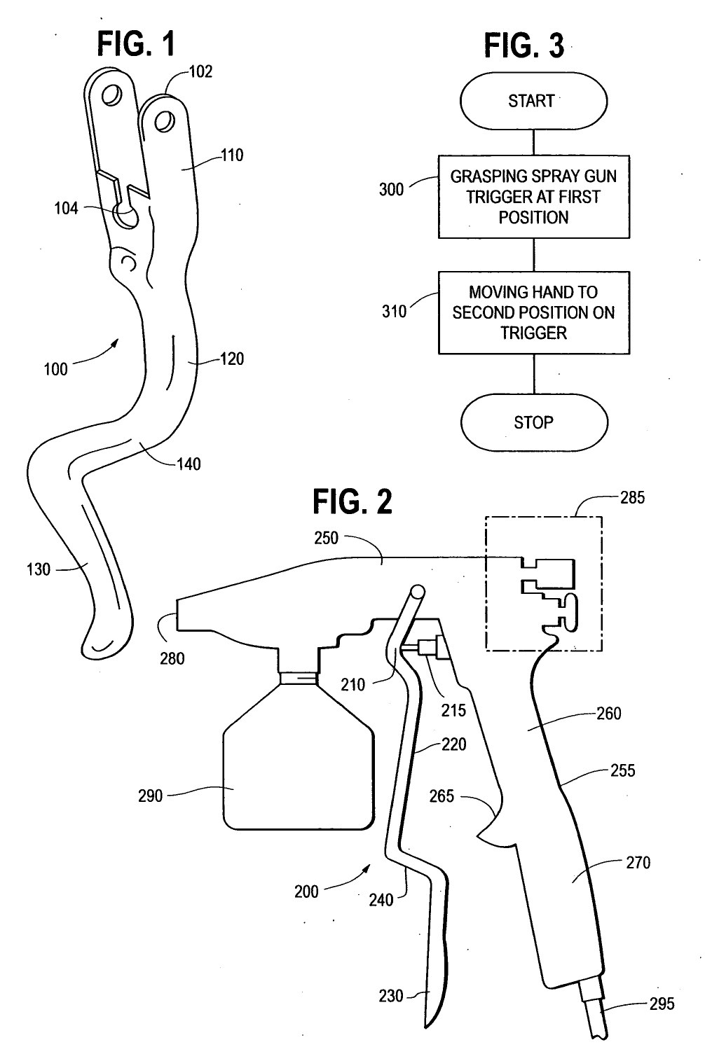

FIG. 1 shows a spray gun trigger 100 that is used to increase the reach of spray from a spray gun. A first end 110 of the trigger is designed and constructed for attachment to a gun body. As known in the art, the first end 110 can include a fork 102 for pivotal attachment, and a slot 104 for operational attachment to the gun body. A middle 120 of the trigger can form a hand grasp, and a second end 130 of the trigger can form an extension. The extension can include a bend 140 that can depend on ergonomic or spray gun design considerations. Alternatively, the second end 130 can be a straight extension without a bend.

An embodiment shown in FIG. 2 depicts an extended trigger 200 attached to a spray gun. A first end 210 of the trigger is pivotally attached to a gun body 250, and is operationally attached to a mechanism 215 that controls the delivery of fluids to a nozzle 297. As known in the art, the mechanism 215 can be spring actuated such that trigger 200 operation requires force such as a squeezing hand to displace the trigger from a starting position. When the force is removed the trigger 200 returns to the starting position. A handle 255 that includes a first hand support 260, a second hand support 270, and a hand rest 265 attaches to the gun body 250. A carrier fluid source 295, such as compressed air, can attach to the handle 255. A primary fluid source 290, such as paint, can be attached to the gun body 250 along with controls 285. As know in the art the controls can be control valves that are used to control the flow and relative quantity of the carrier and primary fluids.

The trigger 200 can be designed and constructed to facilitate operation of the trigger 200 from either the first grasping position 220 or the second grasping position 230. For example, the handle 255 can have a bend 240 that allows the trigger 200 to be drawn proximately close to the handle without contacting the hand rest 265. Alternatively, the bend 240 can be formed to engage the hand rest 265 to help support the spray gun when operating the spray gun from the extending second grasping position 270.

The spray gun can be operated by grasping the first grasping position 220 of the trigger 200 and squeezing towards the handle 255. Squeezing the trigger causes the first end 210 to pivot around a point of attachment on the gun body 250 and operates the mechanism 215 that causes fluids to spray from the gun. The distance that spray can reach from the spray gun depends on how far the spray nozzle can be extended from the operator's grasping hand. For example, operating the trigger 200 from the second grasping position 270 increases the distance that the spray can reach relative to operating the spray gun from the first grasping position 220. Thus, an operator can increase the spray reach by moving a hand grasp from the first grasping position 220 to the second grasping position 230 while maintaining sufficient trigger pressure to operate the mechanism 215.

A flowchart that illustrates a method for use with spraying fluid from a spray gun is shown in FIG. 3. At step 300, the spray gun is operated by grasping the trigger at a first operating position 220. The first hand support 260 and hand rest 265 support the hand while the trigger is squeezed.

At step 310, the spray distance is increased by moving the grasping hand from the first grasping position 220 to the second grasping position 230. When grasping the second grasping position 230 the operating hand rests on the second hand support 270. With the hand in a new position, the trigger 200 is squeezed towards the handle 255. As the trigger 200 is squeezed the bend 240 permits the trigger to move proximately close to the handle without interfering with the hand rest 265. Because the second grasping position 230 is farther from the nozzle 280 than the first grasping position 220, the spray reach can be increased without stopping the spraying operation.

An advantage of the present invention is the increased reach of spray from a spray gun. The trigger 200 of a spray gun can be operated from a first grasping position 220 or a second grasping position 230 without interrupting the spraying operation. This change in the position of the operating hand increases spray reach without stopping the spraying operation. For example, when painting with a spray gun an increased spray reach can eliminate time lost to stop painting and reposition the object being painted or the painter. Continuous painting operation can result in more uniform appearance in the painted surface. Thus, an advantage when painting in short painting times and better appearance of the painted surface.

The present invention can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An apparatus comprising:
a spray gun body attached to a handle and having a nozzle for spraying fluids; and
a trigger having a first end pivotally and operationally attached to the gun body and having at least two grasping positions.

2. The apparatus of claim 1, wherein the handle includes at least two hand supports.

3. The apparatus of claim 1, further comprising a bend between a first grasping position and a second grasping position of the trigger.

4. The apparatus of claim 1, further comprising a paint source attached to the gun body.

5. The apparatus of claim 1, further comprising a compressed air source attached to the gun body.

6. The apparatus of claim 4, further comprising a first control valve operably attached to the paint source and to the trigger.

7. The apparatus of claim 5, further comprising a second control valve operably connected to the compressed air source and to the trigger.

8. A method comprising the steps of:
grasping a trigger at a first position with a hand and squeezing the trigger towards a spray gun handle to spray fluid from a spray gun; and
moving the hand to a second position of the spray gun trigger,
where the distance reached by a fluid spray from the spray gun increases.

9. A method of claim 8, wherein the fluid is paint.

10. A method of claim 8, wherein the second position of the trigger is proximately close to the spray gun handle when the spray gun is operated from the first position of the trigger.
